(19) United States
(12) Patent Application Publication
(10) Pub. No.: US 2011/0058031 A1
(43) Pub. Date: Mar. 10, 2011

(54) IMAGE PROCESSING MEASURING APPARATUS AND IMAGE PROCESSING MEASUREMENT METHOD

(75) Inventors: Masaki KURIHARA, Yokohama (JP); Takeshi SAEKI, Tokyo (JP)

(73) Assignee: MITUTOYO CORPORATION, Kanagawa (JP)

(21) Appl. No.: 12/860,980

(22) Filed: Aug. 23, 2010

(30) Foreign Application Priority Data
Sep. 4, 2009 (JP) 2009-204886

(51) Int. Cl. H04N 7/18

(52) U.S. Cl. 348/135; 348/E07.085

(57) ABSTRACT

An image processing measuring apparatus includes an illuminator that has a red LED, a green LED, and a blue LED; a controller that can independently control illumination intensity of each light source; a color image separator that separates the reflected lights from the measured object into a red light, a green light, and a blue light, respectively converts the lights into a red light image signal, a green light image signal, and a blue light image signal based on each light, and outputs the signals; and an image processor that performs a grayscale image process with respect to one image signal having the same color as that of the radiated light among image signals obtained from the color image separator, when one of the lights from the red LED, the green LED, or the blue LED is radiated onto the measured object.

### CROSS-REFERENCE TO RELATED APPLICATIONS

The present application claims priority under 35 U.S.C. §119 of Japanese Application No. 2009-204886, filed on Sep. 4, 2009, the disclosure of which is expressly incorporated by reference herein in its entirety.

### BACKGROUND OF THE INVENTION

1. Field of the Invention

The present invention is related to an image processing measuring apparatus and image processing measurement method. For example, the invention can be utilized for image edge detection, etc. of a measured object which is colored with R (red), G (green), B (blue), etc.

2. Description of Related Art

An image processing measuring apparatus is known for having an illuminator which radiates a light to a measured object, an image sensor which receives a reflected light from the measured object, and an image processor which calculates a shape of the measured object from the image received by the image sensor (for example, see Related Art 1). With a conventional image processing measuring apparatus, combinations including the following are known as a combination of an illuminator and a sensor:

(a) Combination of a white-light illuminator and a black-and-white image sensor
(b) Combination of a R/G/B color illuminator and a black-and-white image sensor

[Related Art 1] Japanese Patent Laid-Open Publication No. 2004-213986

However, in the above-described configuration, when detecting an edge of the image of a measured object (R/G/B pattern) colored with R/G/B, the edge becomes unclear. Thus, it is difficult to detect an edge accurately.

For example, a case in which an edge of the R/G/B pattern is detected in a measured object colored with R/G/B is illustrated in FIG. 10. In a standard edge detecting of a black-white grayscale image, the brightness value of pixels is quantized to 8 bit (256 gradations), and where the difference in the brightness value is large is determined to be an edge. However, an image obtained in the configuration of (a), the combination of a white-light illuminator and a black-and-white image sensor, is a grayscale image such as one shown in FIG. 11 (A). In this image, as the brightness difference in the edge (the border of colored areas) is small, there is a case in which an edge cannot accurately be detected as exemplified in the brightness distribution map of FIG. 11 (B). Also, FIG. 11 (B) illustrates a brightness distribution of pixels in the dotted areas of the image of FIG. 11 (A). In addition, an image obtained in the configuration of (b), the combination of an R/G/B color illuminator and a black-and-white image sensor, is not sufficient to solve this problem, either.

### SUMMARY OF THE INVENTION

A non-limiting aspect of present disclosure addresses the above-described problem. For example, non-limiting aspect of present disclosure provides an image processing measuring apparatus and an image processing measurement method that improve the accuracy and reliability of an image processing including edge detection of an image of a measured object applied with at least one color or more such as red, green, and blue.

The image processing measuring apparatus according to a non-limiting aspect of present disclosure may have an illuminator that includes a red-emitting light source which emits a red color, a green-emitting light source which emits a green color, and a blue-emitting light source which emits a blue color and can radiate the lights from the light sources onto the measured object; a light source controller that can independently control illumination intensity of the red-emitting light source, the green-emitting light source, and the blue-emitting light source; a color image separator that separates the reflected lights from the measured object into a red light, a green light, and a blue light, respectively converts the lights into a red light image signal, a green light image signal, and a blue light image signal based on each light, and outputs the signals; and a grayscale image processor that performs a grayscale image process with respect to one image signal having the same color as that of the radiated light among image signals obtained from the color image separator, when one of the lights from the red-emitting light source, the green-emitting light source, or the blue-emitting light source is radiated onto the measured object.

According to non-limiting aspect of the configuration above, when detecting an edge between a colored area and other areas in a measured object applied with at least one of red, green, and blue colors, one of the red-emitting light source, the green-emitting light source, or the blue-emitting light source is selected. Then, the light having the same color as the applied color is radiated onto the measured object. The following illustrates an example of detecting an edge between a red area and other areas in a measured object colored with red. When the same red light as the applied color is radiated from the red-emitting light source onto a measured object, a red light image signal obtained from the color image separator generates a red image only in the area colored with red and a black image in the other areas. Then, through a grayscale image processor, a grayscale image is processed with respect to the red light image signal obtained from the color image separator. The grayscale image obtained through this process appears bright for the red area and dark for the other areas. Therefore, in these edges the brightness difference becomes large; thus, an image with clear edges is obtained. Accordingly, accuracy and reliability of image processing such as edge detection is improved with respect to an image of a measured object applied with at least one color or more of red, green, or blue.

According to the image processing measuring apparatus of a non-limiting aspect of present disclosure, it is preferable to have an edge detector that detects a border with a large difference in grayscales as an edge in the grayscale image processed by the grayscale image processor. According to the configuration above, since an edge detector is provided which detects a border with a large difference in grayscales as an edge in the grayscale image, edge detection of the measured object can be accurately performed.

According to the image processing measuring apparatus of a non-limiting aspect of present disclosure, it is preferable that the color image separator has: a dichroic prism separating a reflected light from a measured object into a red light, a green light, and a blue light; and three CCD sensors respectively receiving the red light, the green light, and the blue light separated by the dichroic prism and photo-electrically converting the lights. Since the above-described configuration can be provided with a commercial dichroic prism and three CCD sensors, it can be manufactured at a low cost.

The image processing measurement method according to a non-limiting aspect of present disclosure uses an image processing measuring apparatus to process an image of the measured object and measure a shape and the like of the measured object, the apparatus having: an illuminator that includes a red-emitting light source which emits a red color, a green-emitting light source which emits a green color, and a blue-emitting light source which emits a blue color and can radiate the lights from the light sources onto the measured object; and a color image separator that separates the reflected lights from the measured object into a red light, a green light, and a blue light, respectively converts the lights into a red light image signal, a green light image signal, and a blue light image signal based on each light, and outputs the signals. The method includes: radiating one of the lights from the red-emitting light source, the green-emitting light source, and the blue-emitting light source onto the measured object; and processing a grayscale image with respect to one image signal having the same color as that of the radiation light among the image signals obtained from the color image separator, when one of the lights from the red-emitting light source, the green-emitting light source, and the blue-emitting light source is radiated onto the measured object.

According to the image processing measurement method of a non-limiting aspect of present disclosure, it is preferable to include determining a border having a large difference in grayscales as an edge in the processed grayscale image. According to an image processing measurement method described above, a similar effect as that of the above-described image processing measuring apparatus can be expected.

The image processing measurement method according a non-limiting aspect of present disclosure uses an image processing measuring apparatus to process an image of the measured object and measure a shape and the like of the measured object, the apparatus having: an illuminator that includes a red-emitting light source which emits a red color, a green-emitting light source which emits a green color, and a blue-emitting light source which emits a blue color and can radiate the lights from the light sources onto the measured object; and a color image separator that separates the reflected lights from the measured object into a red light, a green light, and a blue light, respectively converts the lights into a red light image signal, a green light image signal, and a blue light image signal based on each light, and outputs the signals. The method includes: mixing the lights from the red-emitting light source, the green-emitting light source, and the blue-emitting light source, and radiating a selected color light onto the measured object; calculating a hue, when the light of the selected color is radiated onto the measured object, by performing an HLS conversion that captures the red light image signal, the green light image signal, and the blue light image signal obtained from the color image separator; and performing a binarization with the predetermined upper and lower limits as threshold levels concerning the selected color with respect to the calculated hue.

According to the configuration above, when detecting an edge between a colored area and other areas, for example, in a measured object applied with at least one color or more of cyan (Cy), magenta (Mg), and yellow (Ye), one of the red-emitting light source, the green-emitting light source, and the blue-emitting light source is selected and the light with the same color applied is radiated onto the measured object. For example, in a measured object colored with Cy, when detecting an edge between an area colored with Cy and the other areas; the green-emitting light source and the blue-emitting light source are lighted, the light having the same Cy color as the applied color is synthesized, and the synthesized color is radiated onto the measured object. Then, the reflected light from the measured object is separated into a red light, a green light, and a blue light by the color image separator. The red light image signal, the green light image signal, and the blue light image signal are obtained based on each light. Therefore, in the hue calculation, the red light image signal, the green light image signal, and the blue light image signal obtained from the color image separator are captured, and the HLS conversion process is performed to calculate the hue. When the binarization process is performed for the hue calculated in the hue calculation with the predetermined upper and lower limits as threshold levels concerning the selected color in the binarization process, the area of only the color applied is processed bright and other areas are processed dark. Therefore, in these edges the brightness difference becomes large; thus, an image with clear edges is obtained. Accordingly, accuracy and reliability of image processing such as edge detection is improved for an image of a measured object applied with at least one color or more of Cy, Mg, Ye, etc.

The image processing measurement method according to a non-limiting aspect of present disclosure uses an image processing measuring apparatus to process an image of the measured object and measure a shape and the like of the measured object, the apparatus having: an illuminator that includes a red-emitting light source which emits a red color, a green-emitting light source which emits a green color, and a blue-emitting light source which emits a blue color and can radiate the lights from the light sources onto the measured object; and a color image separator that separates the reflected lights from the measured object into a red light, a green light, and a blue light, respectively converts the lights into a red light image signal, a green light image signal, and a blue light image signal based on each light, and outputs the signals. The method includes: mixing the lights from the red-emitting light source, the green-emitting light source, and the blue-emitting light source, and radiating a selected color light onto the measured object; calculating a saturation, when the light of the selected color is radiated onto the measured object, by performing an HLS conversion that captures the red light image signal, the green light image signal, and the blue light image signal obtained from the color image separator; and performing a grayscale image conversion into a grayscale image based on the calculated saturation.

According to the configuration above, when detecting an edge between a colored area and other areas, for example, in a measured object colored with at least one color or more of cyan (Cy), magenta (Mg), and yellow (Ye), the lights from the red-emitting light source, the green-emitting light source and the blue-emitting light source will be radiated onto the measured object. Then, the reflected light from the measured object is separated into the red light, the green light, and the blue light by the color image separator. The red light image signal, the green light image signal, and the blue light image signal are obtained based on each light. Therefore, in the saturation calculation, after the red light image signal, the green light image signal, and the blue light image signal obtained from the color image separator are captured, the HLS conversion is performed to calculate the saturation. Then, it is converted to a grayscale image based on the saturation calculated in the saturation calculation. For the grayscale image obtained by this process, the area of the color applied is processed bright and other areas are processed dark. Therefore, in these edges the brightness difference becomes large; thus, an image with clear edges is obtained. Accordingly, accuracy and reliability of image processing such as edge detection is also improved, for example, for an image of a measured object applied with at least one color or more of Cy, Mg, Ye, etc.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view illustrating an image processing measuring apparatus according to a first embodiment of the present invention;

FIG. 2 illustrates a color image sensor according to the embodiment;

FIG. 3 is a flowchart illustrating a process procedure according to the embodiment;

FIG. 4 (A) illustrates a red color light image obtained with red light illumination according to the embodiment;

FIG. 4 (B) illustrates a grayscale image obtained with red light illumination according to the embodiment;

FIG. 4 (C) illustrates a R pattern line width obtained with red light illumination according to the embodiment;

FIG. 5 (A) illustrates a green color light image obtained with green light illumination according to the embodiment;

FIG. 5 (B) illustrates a grayscale image obtained with green light illumination according to the embodiment;

FIG. 5 (C) illustrates a G pattern line width obtained with green light illumination according to the embodiment;

FIG. 6 (A) illustrates a blue color light image obtained with blue light illumination according to the embodiment;

FIG. 6 (B) illustrates a grayscale image obtained with blue light illumination according to the embodiment;

FIG. 6 (C) a B pattern line width obtained with blue light illumination according to the embodiment;

FIG. 7 illustrates a measured object measured in a second embodiment according to the present invention;

FIG. 8 (A) illustrates a process image extracted from a Cy area according to the second embodiment;

FIG. 8 (B) illustrates a process image extracted from a Mg area according to the second embodiment;

FIG. 8 (C) illustrates a process image extracted from a Ye area according to the second embodiment;

FIG. 9 (A) illustrates an original image of the measured object that is measured in a third embodiment according to the present invention;

FIG. 9 (B) illustrates a grayscale image that is converted to saturation in a third embodiment according to the present invention;

FIG. 10 illustrates a measured object colored with R/G/B;

FIG. 11 (A) illustrates an image obtained in the white color illumination in a conventional configuration; and

FIG. 11 (B) illustrates a grayscale image obtained in the white color illumination in a conventional configuration.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The following describes embodiments of the present invention with reference to the attached drawings.

### First Embodiment

### Configuration of Image Processing Measuring Apparatus

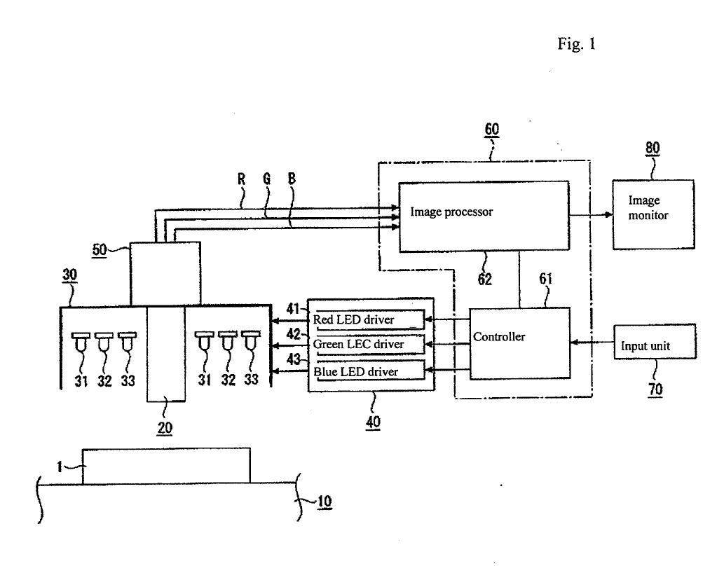

Referring now to the drawings wherein like characters represent like elements, as shown in FIG. 1, an image processing measuring apparatus according to the present invention is configured with a stage 10 having placed a measured object 1, an objective lens 20 installed directly above the stage 10, an illuminator 30 installed in the periphery of the objective lens 20, a driver 40 which drives the illuminator 30, a color image sensor 50 which receives a reflected light from the measured object 1 condensed by the objective lens 20, an image processor 60 which processes image signals R, G, and B from the color image sensor 50 while controlling the driver 40 and calculating the shape, etc. of the measured object 1, and an input unit 70 and an image monitor 80 which are connected to the image processor 60. In addition, the objective lens 20, the illuminator 30, and color image sensor 50 are unified as a unit and are configured to be relatively movable in a 3-D direction with respect to the stage 10.

The illuminator 30 has a red LED (light emitting diode) 31 as a red-emitting light source which emits a red color, a green LED 32 as a green-emitting light source which emits a green color, and a blue LED 33 as a blue-emitting light source which emits a blue color. One or more of each of these red LED 31, green LED 32, and blue LED 33 light sources are installed along the periphery of the objective lens 20 so that the measured object 1 is equally illuminated at or above a certain illumination intensity without unevenness.

The driver 40 applies an electric current to the red LED 31, the green LED 32, and the blue LED 33 and emits these LEDs and includes a red LED driver 41 which applies an electric current to the red LED 31, a green LED driver 42 which applies an electric current to the green LED 32, and a blue LED driver 43 which applies an electric current to the blue LED 33.

The color image sensor 50 configures a color image separator which separates the reflected lights from the measured object 1 condensed by the objective lens 20 to a red light, a green light, and a blue light, respectively converts the lights into a red light image signal R, a green light image signal G, and a blue light image signal B based on each light, and outputs the signals. Specifically, as shown in FIG. 2, the color image sensor 50 is configured with a dichroic prism 51 separating a reflected light from the measured object 1 into a red light, a green light, or a blue light; and three CCD (charge coupled device) sensors 52, 53, and 54 receiving the red light, the green light, and the blue light separated by the dichroic prism 51 and photo-electrically converts the lights. The dichroic prism 51 is composed of three prism elements 51A, 51B, and 51C, and a first dichroic film 51D, and a second dichroic film 51E. The first dichroic film 51D is provided between the prism element 51A and the prism element 51B and reflects a blue light and transmits a red light and a green light. The second dichroic film 51E is provided between the prism element 51B and the prism element 51C and reflects a red light and transmits a green light. CCD sensors 52, 53, and 54 are fixed to the dichroic prism 51 so as to receive a blue light, a red light, and a green light which are separated by the dichroic prism 51.

The image processor 60 includes a controller 61 and an image processor 62. The controller 61 controls the red LED driver 41, the green LED driver 42, and the blue LED driver 43 based on the command from the input unit 70 and independently controls the illumination intensity of the red LED 31, the green LED 32, and the blue LED 33. The image processor 62 captures the red light image signal R, the green light image signal G, and the blue light image signal B from the color image sensor 50 and outputs the signals to the image monitor 80.

The image processor 62 includes a grayscale image processor and an edge detector. The grayscale image processor performs a grayscale image process by capturing an image signal having the same color as that of the radiated light among image signals obtained from the color image sensor 50 when one of the lights from the red LED 31, the green LED 32, or the blue LED 33 is radiated onto the measured object 1. The edge detector detects a border with a large difference in grayscales as an edge in the grayscale image processed by the grayscale processor.

(Measurement Method)

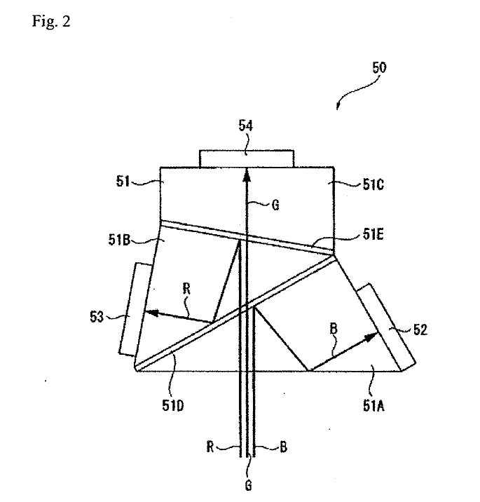

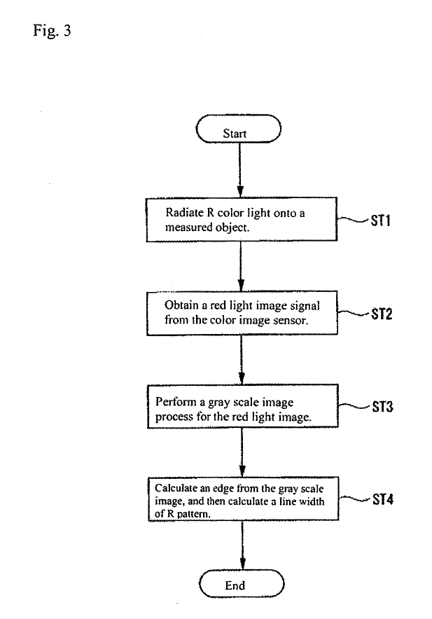

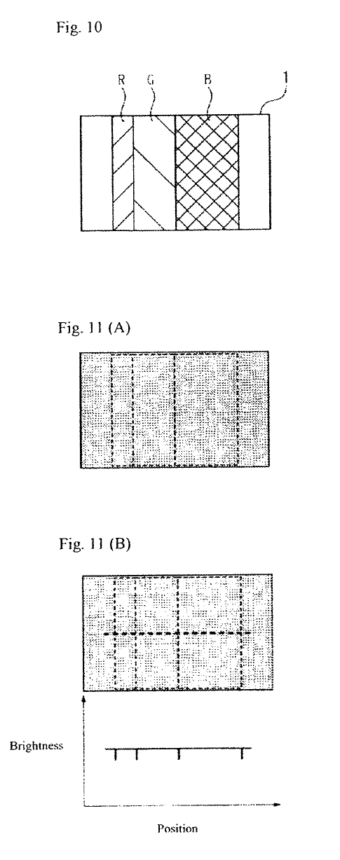

For example, in a measured object 1 colored with R/G/B (see FIG. 10), an example of measuring the line width of R/G/B will be described with reference to the flowchart of FIG. 3. In ST (step) 1, a red light is radiated onto a measured object 1. For this, when the input unit 70 commands only the red LED 31 to be lighted, an applied current value is commanded from the controller 61 to the red LED driver 41. This causes a current to be applied to the red LED 31 from the red LED driver 41, and a red light is radiated onto the measured object 1.

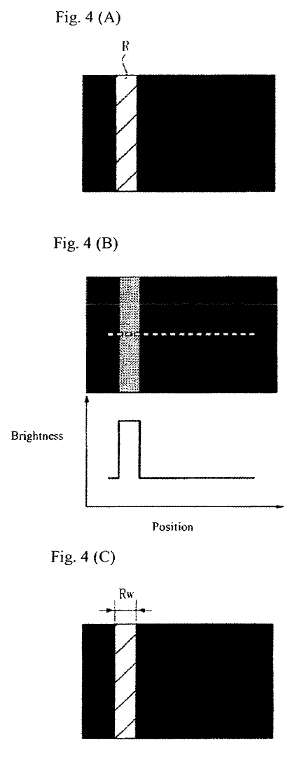

In ST 2, a red light image signal R is obtained which is an image signal that has the same color as that of the radiated light among image signals obtained from the color image sensor 50. In other words, the image processor 62 captures the red light image signal R among image signals obtained from the color image sensor 50 and displays the red light image signal R on the image monitor 80. Then, on the image monitor 80, only the R pattern area is displayed as red, and the other areas are displayed black as shown in FIG. 4 (A).

In ST 3, a red light image is processed as a black-white grayscale image. For example, when the image is converted to a black-white grayscale image of 256 gradations while pixels in the R pattern area are arranged to be the maximum gradations, and the gradations are lowered as the brightness becomes weaker than this, the process is performed as the upper row of FIG. 4 (B) illustrates. When a brightness distribution of the pixels in the dotted area is calculated in the upper row of FIG. 4 (B) at this stage, the brightness distribution map illustrated in the lower row of FIG. 4 (B) is obtained. Looking at the brightness distribution map illustrated in the lower row of FIG. 4 (B), in the borders (edges) between the R pattern area and other areas, the brightness difference becomes large; thus, an image with clear edges is obtained.

In ST 4, the edge of the R pattern is calculated from the grayscale image, as well as the line width of the R pattern. For example, in FIG. 4 (B), the brightness value of pixels in the dotted areas is examined and the position exceeding the threshold levels with a difference in brightness values is determined as an edge. The dimension between the edges is calculated as an R pattern line width Rw (see FIG. 4 (C).)

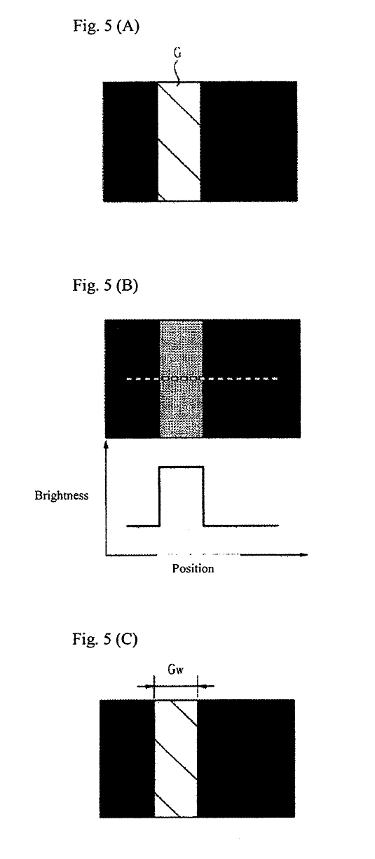

Next, each green light is radiated onto the measured object 1. During radiation, the green light image signal G is obtained among the image signals obtained from the color image sensor 50, and the green light image signal G is processed. FIG. 5 (A) illustrates of an image based on the green light image signal G among the image signals obtained from the color image sensor 50. FIG. 5 (B) is a brightness distribution map illustrating a black-white grayscale image of the green light image and pixels in the dotted areas. FIG. 5 (C) illustrates a G pattern line width Gw calculated from edge detection between the G pattern area and the other areas.

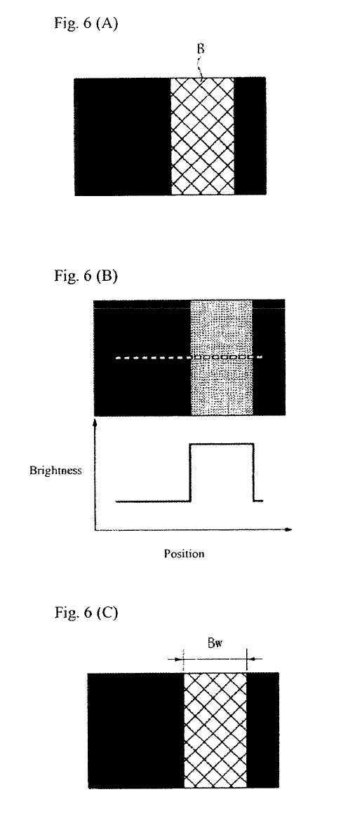

Finally, each blue light is radiated onto the measured object 1. During radiation, the blue light image signal B is obtained among the image signals obtained from the color image sensor 50, and the blue light image signal B is processed. FIG. 6 (A) illustrates an image based on the blue light image signal B among the image signals obtained from the color image sensor 50. FIG. 6 (B) is a brightness distribution map illustrating a black-white grayscale image of the blue light image and pixels in the dotted areas. FIG. 6 (C) illustrates a blue pattern line width Bw calculated from edge detection between the B pattern area and the other areas.

(Effect of the Embodiment)

According to the embodiments of the present invention, each light from the red LED 31, the green LED 32, and the blue LED 33 is individually radiated onto a measured object 1. An image having the same color as that of the radiated light among the red light image signals, the green light image signals, and the blue light image signals obtained from the color image sensor 50 is captured every time each light is radiated and converted into a black-white grayscale image. An image with clear edges between the colored area and other areas is obtained.

Therefore, accuracy and reliability of image processing is improved when an image process is performed such as edge detection, pattern search (pattern matching), etc., with respect to an image of the measured object 1 colored with red, green, and blue that was considered to be difficult in a conventional configuration.

### Second Embodiment

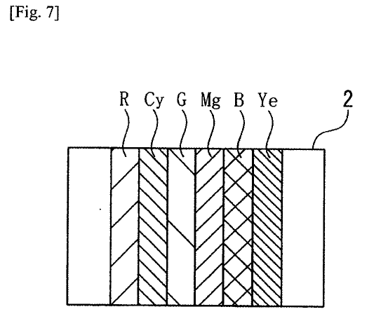

A second embodiment illustrates an example of measuring a line width of Cy/Mg/Ye of a measured object 2 applied with six colors of R/G/B and Cy (cyan)/Mg (magenta)/Ye (yellow) as shown in FIG. 7 by using the image processing measuring apparatus according to the first embodiment. First, when measuring a line width of the area colored with Cy, a light with the same color as Cy is radiated onto the measured object 2. For this measurement, the green LED 32 and the blue LED 33 are lighted and these lights are synthesized, which provides the light having the same Cy color. Then, the light with the same color as the synthesized Cy is radiated onto the measured object 2. In this state, the image processor 62 captures each color image signal (the red light image signal R, the green light image signal G, and the blue light image signal B) obtained from the color image sensor 50. This is converted to the HLS color space from the RGB color space to calculate a hue H. For this procedure, each color image signal is first converted to the YCC color space, then to the HLS color space, and then the hue H is calculated.

In this calculation, the YCC color space refers to a color space using a luma component Y and chrominance component C₁ and C₂. The brightness signal Y and the chrominance component C₁ and C₂ are expressed in the following formula. In addition, Y, R, G, and B have 8-bit (256 gradations: 0˜255).

Y=0.299R+0.587G+0.144B formula (1)

C₁=R−Y=0.701R−0.587G−0.144B formula (2)

C₂=B−Y=−0.299R−0.587G+0.886B formula (3)

Also, the HLS color space refers to a color space using three characters of color: hue H (hue), luminance L (light/luminance), saturation S (saturation). The hue H, luminance L, and saturation S are expressed in the following formula.

H=tan⁻¹(C₁/C₂) formula (4)

L=Y formula (5)

S=√(C₁²+C₂²) formula (6)

For reference, Chart 1 shows the hue H, luminance L and saturation S of the representative colors (R/Ye/G/Cy/B/Mg).

CHART 1

| | R | Ye | G | Cy | B | Mg |
|---|---|---|---|---|---|---|
| H (hue) | 113.1° | 172.7° | 225.0° | 293.1° | 352.7° | 45.0° |
| L (luminance) | 76.2 | 225.9 | 149.7 | 178.8 | 29.1 | 105.3 |
| S (saturation) | 0.762 | 0.893 | 0.830 | 0.762 | 0.893 | 0.830 |

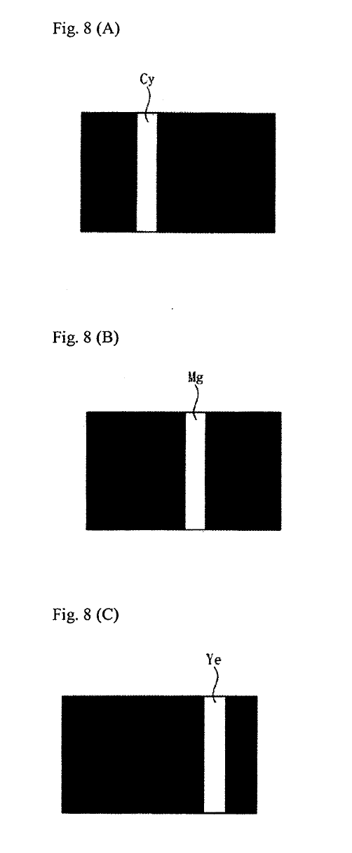

The image processor 62 captures each image color signal obtained from the color image sensor 50. After a hue H is calculated from the above-described formula (4), the binary code process is performed for the hue H of the selected Cy. In this example, the two threshold levels of the upper and lower limits are predetermined concerning the hue H of the preselected color. For example, in the case of Cy, it is arranged that the lower limit is 290° and the upper limit is 300°. Then, the image processor 62 binarizes the pixels between the lower limit (290°) and the upper limit (300°) as “white” and the pixels of the other values as “black”, the image of which is displayed on the image monitor 80. On the image monitor 80, the only area colored with Cy is displayed white and other areas are displayed black as shown in FIG. 8 (A). From this display, the line width of the area colored with Cy can be calculated.

Next, when measuring a line width of the Mg area, a light with the same color as Mg is radiated onto the measured object 2. For this measurement, the red LED 31 and the blue LED 33 are lighted and these lights are synthesized, which provides the light having the same Mg color. Then, the light having the same synthesized Mg color is radiated onto the measured object 2. In this state, the image processor 62 captures each color image signal obtained from the color image sensor 50. After a hue H is calculated from the above-described formula (4), the binary code process is performed for the hue H of the selected Mg. For example, in the case of Mg, it is arranged that the lower limit is 40° and the upper limit is 50°. Then, the image processor 62 binarizes the pixels between the lower limit (40°) and the upper limit (50°) as “white”, and the pixels of the other values as “black”, the image of which is displayed on the image monitor 80. On the image monitor 80, the only area colored with Mg is displayed white and other areas are displayed black as shown in FIG. 8 (B). From this display, the line width of the area colored with Mg can be calculated.

Finally, when measuring a line width of the Ye area, a light with the same color as Ye is radiated onto the measured object 2. For this measurement, the red LED 31 and the green LED 32 are lighted and these lights are synthesized, which provides the light having the same Ye color as the applied color. Then, the light having the same synthesized Ye color is radiated onto the measured object 2. In this state, the image processor 62 captures each color image signal obtained from the color image sensor 50. After a hue H is calculated from the above-described formula (4), the binary code process is performed for the hue H of the selected Ye. For example, in the case of Ye, it is arranged that the lower limit is 170° and the upper limit is 180°. Then, the image processor 62 binarizes the pixels between the lower limit (170°) and the upper limit (180°) as “white”, and the pixels of the other values as “black”, the image of which is displayed on the image monitor 80. On the image monitor 80, the only area colored with Ye is displayed white and other areas are displayed black as shown in FIG. 8 (C). From this display, the line width of the area colored with Ye can be calculated.

In addition, in the second embodiment, the image processor 62 performs the above-described processing steps. Specifically, the image processor 62 has a hue calculator that captures the red light image signal R, the green light image signal G, and the blue light image signal B obtained from the color image sensor 50 when the light with the selected color is radiated onto the measured object and performs the HLS conversion to calculate the hue. The image processor 62 also has a binary code processor that performs a binary process for the hue calculated by the hue calculator with the predetermined upper and lower limits as threshold levels concerning the selected color.

### Third Embodiment

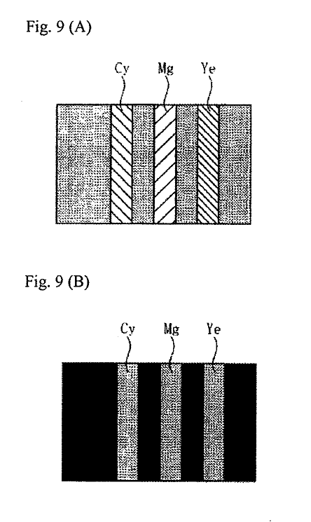

A third embodiment is an instance of measuring the line width of Cy/Mg/Ye of a measured object colored with Cy/Mg/and Ye using the image processing measuring apparatus according to the first embodiment. First, the red LED 31, the green LED 32 and the blue LED 33 are lighted and the synthesized light (white) of these LEDs is radiated onto the measured object 2. In this state, the image processor 62 captures each color image signal (R, G, B) obtained from the color image sensor 50. This is converted to the HLS color space from the RGB color space to calculate a saturation S and then converted to a grayscale image based on the saturation S. In other words, after the saturation S is calculated from the formula (6), it is converted to a grayscale image based on the saturation S. FIG. 9 (A) is an original image obtained from each color image signal from the color image sensor 50. In the figure, while the saturation of the background area of the original image is small, the saturation of the area colored with Cy/Mg/Ye is large. Therefore, when the original image is converted to a grayscale image of the saturation S, the brightness difference between the area colored with Cy/Mg/Ye and that of other areas becomes large as shown in FIG. 9 (B); thus, edge detection can be performed. For example, when the brightness value of the pixels crossing the area colored with Cy/Mg/Ye is examined and the position exceeding the threshold having a difference in the brightness value is judged as an edge, the dimension between this edge can be provided as a line width of Cy/Mg/Ye.

In addition, in the third embodiment, the image processor 62 performs the above-described processing steps. Specifically, the image processor 62 has a saturation calculator that captures the red light image signal R, the green light image signal G, and the blue light image signal B obtained from the color image sensor 50 when a light with the selected color is radiated onto the measured object and performs the HLS conversion to calculate the saturation. The image processor 62 also has a grayscale image convertor that performs a conversion to the grayscale image based on the saturation calculated in the saturation calculation step.

### Alternative Embodiment

The present invention is not limited to the above-described embodiments and includes the variations and improvements within the scope of achieving the purpose of the invention. In the above-described embodiments, the cases were explained where edge detection is performed for an image of the measured object that is applied with R/G/B, or R/G/B and Cy/Mg/Ye. However, concerning the color applied to the image, the present invention can be used when at least one of these colors or when colors other than these are applied.

In the above-description, the illuminator 30 has a red LED 31, a green LED 32, and a blue LED 33. However, the configuration is not limited to LEDs. For example, a combination of an incandescent bulb and a color filter may be used. In addition, although the color image sensor 50 has a dichroic prism and three image sensors, the configuration is not limited to the above description. For instance, instead of a dichroic prism, a reflected light from the measured object may be arranged so that it is separated into red, green, and blue lights using a dichroic minor and the separated lights may be arranged to be received by three image sensors for photo-electric conversion.

The present invention can be used for an image processing measuring apparatus, an image processing measurement method, and the like in which image processing such as edge detection is performed and the shape, and the like of the measured object is measured, for example, with respect to an image of the measured object applied with at least one color of red, green, blue, etc.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An image processing measuring apparatus comprising:
an illuminator comprising a red-emitting light source which emits a red color, a green-emitting light source which emits a green color, and a blue-emitting light source which emits a blue color, the illuminator configured to radiate light from the light sources onto the measured object;
a light source controller configured to independently control illumination intensity of the red-emitting light source, the green-emitting light source, and the blue-emitting light source;
a color image separator configured to: separate the reflected lights from the measured object into a red light, a green light, and a blue light; convert the lights into a respective red light image signal, green light image signal, and blue light image signal based on each light; and output the signals; and
a grayscale image processor configured to perform a grayscale image process with respect to one image signal having the same color as that of the radiated light among image signals obtained from the color image separator, when one of the lights from the red-emitting light source, the green-emitting light source, or the blue-emitting light source is radiated onto the measured object.

2. The image processing measuring apparatus according to claim 1 further comprising an edge detector configured to detect a border with a large difference in grayscales as an edge in the grayscale image processed by the grayscale image processor.

3. The image processing measuring apparatus according to claim 1, wherein the color image separator comprises:
a dichroic prism separating a reflected light from a measured object into a red light, a green light, and a blue light; and
three CCD (charge coupled device) sensors configured to respectively receive the red light, the green light, and the blue light separated by the dichroic prism, the three CCD sensors further configured to photo-electrically convert the lights.

4. An image processing measurement method which uses an image processing measuring apparatus to process an image of the measured object and measure a shape and the like of the measured object, the apparatus including an illuminator that includes a red-emitting light source which emits a red color, a green-emitting light source which emits a green color, and a blue-emitting light source which emits a blue color and can radiate the lights from the light sources onto the measured object, the apparatus further including a color image separator that separates the reflected lights from the measured object into a red light, a green light, and a blue light, respectively converts the lights into a red light image signal, a green light image signal, and a blue light image signal based on each light, and outputs the signals, the method comprising:
radiating one of the lights from the red-emitting light source, the green-emitting light source, and the blue-emitting light source onto the measured object; and
processing a grayscale image with respect to one image signal having the same color as that of the radiation light among the image signals obtained from the color image separator when one of the lights from the red-emitting light source, the green-emitting light source, and the blue-emitting light source is radiated onto the measured object.

5. The image processing measurement method according to claim 4, further comprising determining a border having a large difference in grayscales as an edge in the processed grayscale image.

6. An image processing measurement method that uses an image processing measuring apparatus to process an image of the measured object and measure a shape and the like of the measured object, the apparatus including an illuminator that includes a red-emitting light source which emits a red color, a green-emitting light source which emits a green color, and a blue-emitting light source which emits a blue color and can radiate the lights from the light sources onto the measured object, the apparatus further including a color image separator that separates the reflected lights from the measured object into a red light, a green light, and a blue light, respectively converts the lights into a red light image signal, a green light image signal, and a blue light image signal based on each light, and outputs the signals, the method comprising:
mixing the lights from the red-emitting light source, the green-emitting light source, and the blue-emitting light source, and radiating a selected color light onto the measured object;
calculating a hue, when the light of the selected color is radiated onto the measured object, by performing a Hue, Luminance, and Saturation (HLS) conversion that captures the red light image signal, the green light image signal, and the blue light image signal obtained from the color image separator; and
performing a binarization with the predetermined upper and lower limits as threshold levels concerning the selected color with respect to the calculated hue.

7. An image processing measurement method that uses an image processing measuring apparatus to process an image of the measured object and measure a shape and the like of the measured object, the apparatus including an illuminator that includes a red-emitting light source which emits a red color, a green-emitting light source which emits a green color, and a blue-emitting light source which emits a blue color and can radiate the lights from the light sources onto the measured object, the apparatus further including a color image separator that separates the reflected lights from the measured object into a red light, a green light, and a blue light, respectively converts the lights into a red light image signal, a green light image signal, and a blue light image signal based on each light, and outputs the signals, the method comprising:
mixing the lights from the red-emitting light source, the green-emitting light source, and the blue-emitting light source, and radiating a selected color light onto the measured object;
calculating a saturation, when the light of the selected color is radiated onto the measured object, by performing a Hue, Luminance, and Saturation (HLS) conversion which captures the red light image signal, the green light image signal, and the blue light image signal obtained from the color image separator; and
performing a grayscale image conversion into a grayscale image based on the calculated saturation.

8. The image processing measuring apparatus according to claim 2, wherein the color image separator comprises:
a dichroic prism separating a reflected light from a measured object into a red light, a green light, and a blue light; and
three CCD (charge coupled device) sensors configured to respectively receive the red light, the green light, and the blue light separated by the dichroic prism, the three CCD sensors further configured to photo-electrically convert the lights.
